(19) United States
(12) Patent Application Publication
(10) Pub. No.: US 2016/0063109 A1
(43) Pub. Date: Mar. 3, 2016

(54) QUERY-BREADTH SELECTED SEARCH RESULT SORTING MECHANISM

(71) Applicants: Yuanjie Liu, Shanghai (CN); David Goldberg, Palo Alto, CA (US); Michael Ching, San Jose, CA (US); Xiaoyuan Wu, Shanghai (CN); Joseph Anthony Beynon, Campbell, CA (US); Song Feng, San Jose, CA (US)

(72) Inventors: Yuanjie Liu, Shanghai (CN); David Goldberg, Palo Alto, CA (US); Michael Ching, San Jose, CA (US); Xiaoyuan Wu, Shanghai (CN); Joseph Anthony Beynon, Campbell, CA (US); Song Feng, San Jose, CA (US)

(21) Appl. No.: 14/472,985

(22) Filed: Aug. 29, 2014

(51) Int. Cl. G06F 17/30

(52) U.S. Cl. CPC G06F 17/30864; G06F 17/3053; G06F 17/30554

(57) ABSTRACT

Systems and techniques for a query-breadth selected search result sorting mechanism are herein described. A search query can be received from a user. A breadth score can be generated for the search query. A sorting mechanism can be selected from a plurality of sorting mechanisms based on the breadth score. Search results can be identified for the query and the selected sorting mechanism can be applied to the search results to produce an ordered set of search results. The ordered set of search results can be presented to the user.

### BACKGROUND

Repositories of electronic resources (e.g., articles, programs, images, product listings, etc.) can be too large for users to effectively manage. Search engines can often provide a mechanism by which users can effectively access electronic resources in a large repository. Generally, a user enters a search that is then parsed by the search engine and used to locate relevant electronic resources. The search engine can include, or can employ, a sorting mechanism to facilitate presentation of relevant results to the user.

### BRIEF DESCRIPTION OF DRAWINGS

Various ones of the appended drawings merely illustrate example embodiments of the present invention and cannot be considered as limiting its scope.

FIG. 1 illustrates an example of a system for a query-breadth selected search result sorting mechanism, according to an embodiment.

FIG. 2 illustrates a block diagram of an example of a system for selecting a sorting mechanism based on query-breadth, according to an embodiment.

FIG. 3 illustrates a flow diagram of an example of a method for a query-breadth selected search result sort mechanism, according to an embodiment.

FIG. 4 is a block diagram of a machine in an example form of a computing system within which a set of instructions for causing the machine to perform any one or more of the methodologies discussed herein can be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of an embodiment of the inventive subject matter. It will be evident, however, to those skilled in the art, that embodiments of the inventive subject matter can be practiced without these specific details. In general, well-known instruction instances, protocols, structures, and techniques have not been shown in detail.

Traditional search engines can employ a variety of techniques to address the problem of providing relevant results to users. Examples can include indexing the electronic resources in a variety of ways, observing user behavior and applying the observations to discern perceived quality of previous search results, etc. However, these techniques often assume a common purpose to the search query, that of finding a specific set of electronic resources to use. For example, if a user searches on a marketplace, the assumption is often that the user wants to click on a product (e.g., item, good, service, etc.) and purchase that product. Similarly, if the user searches on a reference (e.g., encyclopedia, dictionary, etc.), the assumption is often that the user wants to pick an article to answer the question posed by the query.

In contrast to prior approaches, a first determination as to the user's intent for a search can be made and used to inform what types of results can help the user. For example, if the search query is broad, it can be inferred that the user is attempting to survey a topic rather than looking for a specific resource. Similarly, if the search query is narrow, if can be inferred that the user is looking for something specific to act upon. In this context, different sorting, or searching, mechanisms can be used depending on the breadth of the search query. For example, if the user searches for “music players,” which can be considered a broad search, a sorting mechanism that will return a variety of electronic resources—such as reviews, top selling music players, accessories for music players, medical articles about the dangers of various music players, etc.—can be used. In contrast, if the search was for a wearable, solid-state storage music player in lime green from 2013, which can be considered a narrow search, a sorting mechanism that will, for example emphasize quality vendors that have such a music player in stock, can be used.

The importance of such differential sorting is made clear when the limited space to display search results is appreciated. Users often rely on the first results returned, and often do not pass the first page (e.g., single screen, web-page, of scrollably accessible content) when deciding which offered resources to access. Thus, determining that the user is browsing and emphasizing a variety of different types of results in the highest ordered positions can provide the user with a convenient platform to continue her inquiries. Also, when the user knows exactly what they are looking for, and for example, provides a narrow search query, returning targeted resource to the specific subject can provide the user with options to obtain the specific material requested.

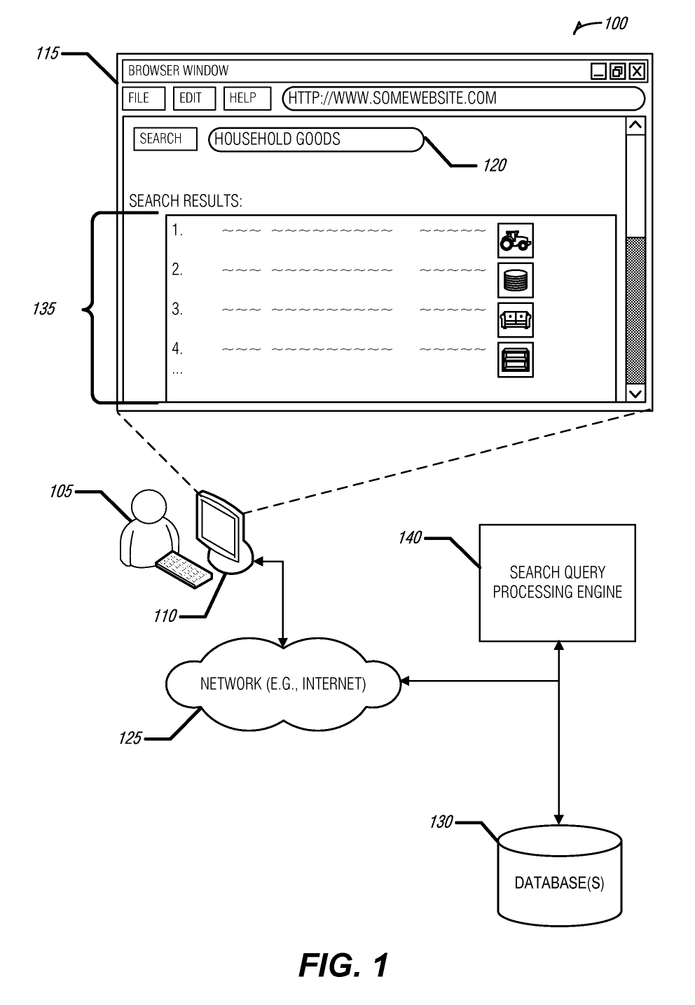

FIG. 1 illustrates an example of a system 100 for a query-breadth selected search result sorting mechanism. The system 100 can include a client device 110 (e.g., operated by a user 105), a user interface 115, a search query processing engine 140 communicatively coupled to a database(s) 130 (e.g., a storage mechanism for an electronic resource repository) and to the client device 110, for example, via the network 125.

The client device 110 can be configured to implement input (e.g., via a pointing device, touch input, keyboard, voice commands, etc.) or output (e.g., graphics, sounds, haptic feedback, etc.) aspects of the user interface 115. The user interface 115 can include a search query entry portion 120 and a listing portion to display search results 135. As illustrated, the user interface 115 is a web page. However, other user interfaces can be used, such as a mobile platform (e.g., cellular phone, tablet, etc.) application (e.g., an “app”), a desktop “fat-client” application, etc.

The database(s) 130 can include an electronic resource repository. In an example, the database(s) 130 can also include meta-data about any or all of the electronic resources in the repository, user behavior with respect to the repository, company goals with regard to the repository, etc. This meta-data can be used to modify a search query from the user 105, facilitate search result identification, or the like. User behavior can include transaction data (e.g., was an item purchased, an article used, etc.), interaction data (e.g., was a link clicked, viewed, etc.), as well as query choice behavior (e.g., what keywords were used, what queries have been received, etc.).

The search query processing engine 140 is configured to receive a search query (e.g., via user interface element 120) from the user 105 and return a set of search results 135. As discussed above, selection and ordering of the search results 135 provides the user 105 with greater utility in accessing the repository in the database(s) 130. The search query processing engine 140 is configured to use the search query and the meta-data in the database 130 to identify search results 135 and also to order those search results 135.

In an example, the database 130 includes one or more attribute-models that the search query processing engine 140 can use to order the search results 135. As used herein, an attribute-model is a structural arrangement of one or more attributes (e.g., such as a class of meta-data discussed above) of the repository or the electronic resources in the repository. Thus, the model accepts input, produces output, and defines what attributes are included as input, the interrelated effect each attribute has on model output. An individual attribute can be used to order a search result. For example, if the attribute is whether a news article includes a picture (e.g., a picture model), articles in the repository can be ranked based on whether or not they include a picture. Other example attributes can include keyword affinity between a search query and the electronic resource (or its meta-data), user click behavior (e.g., recorded history of what and when users click on), viewing behavior (e.g., recorded history of what, when, or for how long a user viewed something), picture quality, currency (e.g., what currency is at issue, exchange rates, etc.), word counts, distance between parties (e.g., sellers and buyers), author history or reputation (e.g., a seller's selling history or history of complaints, etc.), among others.

Returning to the example of a picture attribute (e.g., does a picture exist or not for a news article), it can be appreciated that such an attribute is likely binary and less helpful for determining relevant news articles when many have pictures (or don't). Accordingly, an attribute-model can combine a number of different attributes to produce a composite output (e.g., ordering value) for the electronic resources. While a numbering of different compositing techniques can be used, such as weighted combination or ordered application of attributes (e.g., apply one attribute sorting first, and then a second attribute sorting on the results of the first sorting, etc.), nearly every compositing technique can emphasize one or more attributes over other attributes. As used herein, a given (e.g., specific, unique, etc.) attribute-model includes a set of attributes and a specific emphasis (e.g., weighting) between those attributes. For the sake of simplicity, for example, a click attribute-model at least includes a click behavior attribute and emphasizes the click behavior attribute above other attributes in the click attribute-model.

The search query processing engine 140 can also be configured to determine (e.g., calculate, obtain, etc.) a breadth score for the search query. In an example, the breadth score can be a bounded or unbounded linear range of numbers. For example, a bounded linear range can include a number (e.g., integer, rational number, irrational number, etc.) with a lowest value and a highest value, expressed as a value u, value l, and an ordered set S, such that, ∀s ε S: s≧l; s≦u.

A variety of mechanisms can be used to determine a breadth score. Accordingly, one breadth score type may be different than another breadth score type for the same search query. For example, the breadth score can be determined via semantic processing of the query to determine breadth. In another example, historical user behavior (e.g., the user 105 or a collection of other users) with respect to the query can be analyzed to determine breadth. In this example, generally, if the query is associated with an immediate action (i.e., a direct transaction), the query can be considered narrow. Further, if the query is followed by additional queries (e.g., to refine the search based on the first search results 135) before an action (i.e., an indirect transaction), the query can be considered broad. In an example, an additional query can be a user specified refinement to the search query (e.g., entered via the user interface 115). Such a refinement can include, specifying a different sort term, weight, category, price range, brand name, or other standard post-search result refinement options to searches. In an example, the additional query can include selecting a subsequent page of a paginated set of search results. For example, selecting the second page of a search query returning four pages of search results 135 is the additional query. In an example, a plurality of breadth score types can be combined into a composite breadth score. In an example, the breadth score is not based on the potential search results. For example, given a very large number of marketplace listings for an essentially fungible item, a very narrow search for that item can potentially return a large number of results. Thus, in this example, simply comparing the number of potential search results 135 between possible search queries is insufficient to provide the breadth score.

As discussed above, the breadth score can be used to infer the user's intent with respect to the search query. Although a variety of intents can be inferred by the breadth score, for simplicity, the following examples will use “browsing” and “executing” as the two ends of the intent spectrum. Attributes can have different affinities to these two intents. For example, while browsing, high quality pictures can be a useful tool for the user 105. Accordingly, a picture quality attribute can be given greater emphasis than other attributes to facilitate the user's browsing. Similarly, for example, when executing (e.g., purchasing a product), a seller's rating attribute can facilitate user identification of reliable vendors from which to purchase an item. Accordingly, attributes can be linked to user intent, and thus ranked, amongst themselves, when a given intent is determined.

Because the breadth score is a proxy for the intent, attributes can be assigned a relative value to each other that varies with a given breadth score. The value can be assigned in a static manner, via application of a function, or other mechanism. In an example, attribute-models can be indexed to the range of breadth scores. Thus, given a particular breadth score, a particular attribute-model is selected based on a predetermined index of the attribute-models.

In an example, the search query processing engine 140 can be configured to use the determined breadth score directly with ranked attributes. For example, attributes can be assigned a binary affinity value to breadth (e.g., an attribute can be assigned the label “browsing attribute” if the attribute works better to order the search results 135 for a broad search query or assigned the label “executing attribute” if the breadth score works better to order the search results 135 for a narrow search query). The breadth score can then be selectively applied to each attribute as part of a weight in combining the attributes in the attribute-model. The selective application is based on the affinity value. For example, if the breadth score is between zero and one, one being the strongest indication of a browsing intent and zero being the strongest indication of an executing intent, an example attribute-model can be expressed as, BS*A_{B}+(1−BS)A_{E}, where BS is the breadth score, A_{B} is an attribute with browsing affinity and A_{E} is an attribute with executing affinity.

The attribute-models described above are a type of sorting mechanism. Selecting a particular attribute-model and modifying the characteristics of an attribute-model are examples of selecting a sorting mechanism based on the breadth score. In spite of these illustrative examples, the search query processing engine 140 can be configured to select one sorting mechanism out of a set of sorting mechanisms using the breadth score is a component of the decision making process. For example, the search query processing engine 140 can have access to one or more external data resources or search engines. In an example, external resources can include a search engine, remotely hosted database, document repository, partner web-site, library, industry publications, etc. These external resources can be ordered, or evaluated, with regard to the breadth score. In an example, the external and internal resources can be mixed based on the breadth score.

As detailed above, selecting a sorting mechanism based on the breadth of a search query allows the system 100 to provide results relevant with the user's intent without burdening the user 105 with additional inputs (e.g., to specifically signal their intent). Accordingly, the system 100 addresses the problem of providing relevant results to users better than previous solutions.

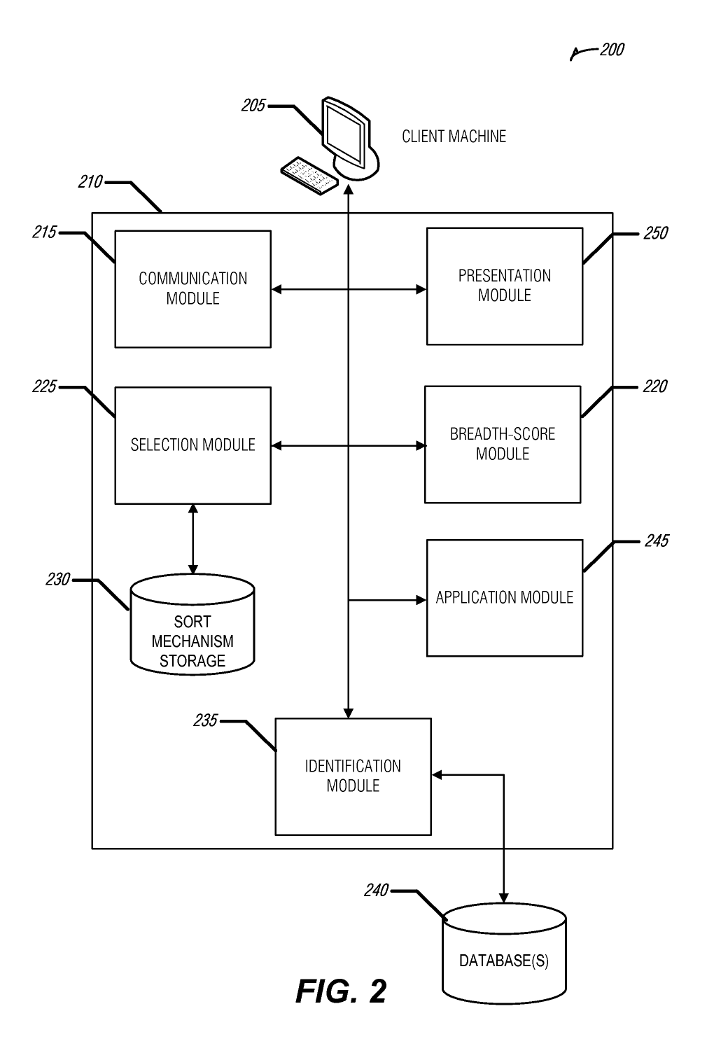

FIG. 2 illustrates a block diagram of an example of a system 200 for selecting a sorting mechanism based on query-breadth, according to an embodiment. The system 200 is another configuration, like the system 100, that can be used to use a breadth score to select a sorting mechanism for search queries and search query results. The system 200 can include a client machine 205 and databases, similar to those discussed above with respect to the system 100. Further, the system 200 can include a processing engine 210. In an example, the processing engine 210 can be used to implement the search query processing engine 140 discussed above.

The processing engine 210 can include a communication module 215, a breadth-score module 220, a selection module 225, a sort mechanism storage database 230, an identification module 235, an application module 245, and a presentation module 250. One or all of the processing engine 210's modules can reside on disparate hardware platforms (e.g., different physical nodes, virtual nodes, different operating systems, etc.). In an example, any given one of the processing engine 210's modules can be implanted on multiple physical machines (e.g., as a mesh network, cluster of machines, etc.). The processing engine 210 or any of its modules can be configured to communicatively couple to the client machine 205 or the database(s) 240 when in operation.

The communication module 215 can be configured to receive a search query from a user (e.g., entered via the client machine 205).

The breadth-score module 220 can be configured to generate (e.g., determine, calculate, obtain, etc.) a breadth-score for the search query. In an example, the breadth score can be based on comparing direct and indirect transactions from historical user sessions including the search query. As discussed above, direct transactions are those transactions in which an additional query was not performed between returning the search results for the search query and the user executing a transaction. Indirect transactions include an additional search query between the user receiving the search results for the search query and executing a transaction. The search query and the additional search query correspond to queries executed by users with a single user session from historical data. In this context, the additional query is considered a sub-session to a user session begun by the search query. In an example, the additional query is related to the search query. Thus, even within a user session, sub-sessions can be identified via relation criteria common to the search query and the additional search query. For example, in a user session, the user may have searched for, in order, “sneakers,” “household goods,” “dinnerware,” and “red 12 inch ceramic plates.” In this example, the second through fourth queries are related as all being household goods while the first query is an unrelated clothing article. Thus, with respect to the second query, queries three and four can represent sub-sessions. In an example, two queries can be considered related if they share a common term.

In an example, the session and sub-session historical data can be used to determine the breadth score for a given search query present in the historical data. For example, comparing the direct to indirect transactions can include dividing the direct transactions in the historical data by a combination of the direct and indirect transactions, expressed as,

$$\frac{U}{U + U O} ,$$

where U are the number or users who executed a transaction after entering the search query and UO are the number of users who had at least one sub-session after entering the search query. In the context of purchasing an item, this calculation can be referred to as immediate sales over total sales (ISoTS) for the search query. In an example, the ISoTS range is between zero and one inclusive, or [0, 1].

The selection module 225 can be configured to select a sorting mechanism (e.g., from the sort mechanism storage database 230) from a plurality of sorting mechanisms based on the breadth score. In an example, as discussed above, this selection can be a lookup, using the breadth score as a key. In an example, the selecting includes modifying an existing sorting mechanism with the breadth score to create a version of the sorting mechanism specific to the breadth score. This is akin to the attribute-model modification where the breadth-score is a coefficient, or weight, applied to attributes in the attribute-model. In an example, the sorting mechanism can be chosen from internally available mechanisms (e.g., those stored in the sort mechanism storage database 230). In an example, the sorting mechanism can include an external resource, such as a searching engine, remotely hosted database, document repository, partner web-site, etc.

As discussed above, the sorting mechanisms can be individually associated with breadth or narrowness. Thus, a breadth score indicating a narrow search query can be paired with a search mechanism, for example, likely to result in a direct (e.g., immediate) transaction. In an example, the sorting mechanism can be selected based on a relationship to a threshold. For example, if the breadth score is greater than a threshold, a first sorting mechanism can be selected while if the breadth score is less than the threshold, a second sorting mechanism can be selected. In an example, the threshold, perhaps in combination with other thresholds or the boundaries of the breadth score range, can divide the breadth score range into regions, and each of the plurality of sorting mechanisms can correspond to the regions. For example, given two regions and one threshold (e.g., a binary model), where a low ISoTS represents a broad search query and a high ISoTS score represents a narrow search query, if the ISoTS score is below the threshold, a click model (e.g., that a user clicked on a link following the search query) can be used while a sales model (e.g., a user purchased an item immediately following the search query) can be used when the ISoTS score is above the threshold.

The identification module 235 can be configured to identify search results for the search query (e.g., from the database(s) 240). The identification of search results can include using the search query and other context data, such as demographic or other personal information about the user, time of day, time of week, time of month, time of year, or other information used to present relevant results to the user based on the search query. In an example, identification of the search results can include incorporating business, or business partner interests, in addition to the search query to produce the search results. In an example, the selected sorting mechanism can also be used to identify the search results. For example, a sorting mechanism can emphasize diversity between electronic resources (e.g., goods, reviews, services, news stories, etc.). In such a case, the search results can be expanded to other sources in order to provide the desired diversity.

The application module 245 can be configured to apply the sorting mechanism (e.g., the selected sorting mechanism) to the search results to produce an ordered set of search results. That is, once a list of search results is identified, the elements of the search results can be ordered using the sorting mechanism. Thus, the determination of the breadth score for the query transforms the mass of electronic resources in the database(s) 240 into an ordered list based on the breadth score determination.

The presentation module 250 can be configured to present the ordered set of search results to the user (e.g., via a search result user interface communicated to the client machine 205 directly or via the communication module 215). In an example, the presentation module 250 can be configured to provide the user interface to the client machine 205. In an example, the presentation module 250 can be configured to provide a service from which the user interface 115 can obtain the ordered list of search results. As discussed above, the presentation of the ordered search results can be performed via a thin-client (e.g., web page or similar interface), a fat client (e.g., a client-side application), mobile application, or other mechanism sufficient to present the ordered search results to the user.

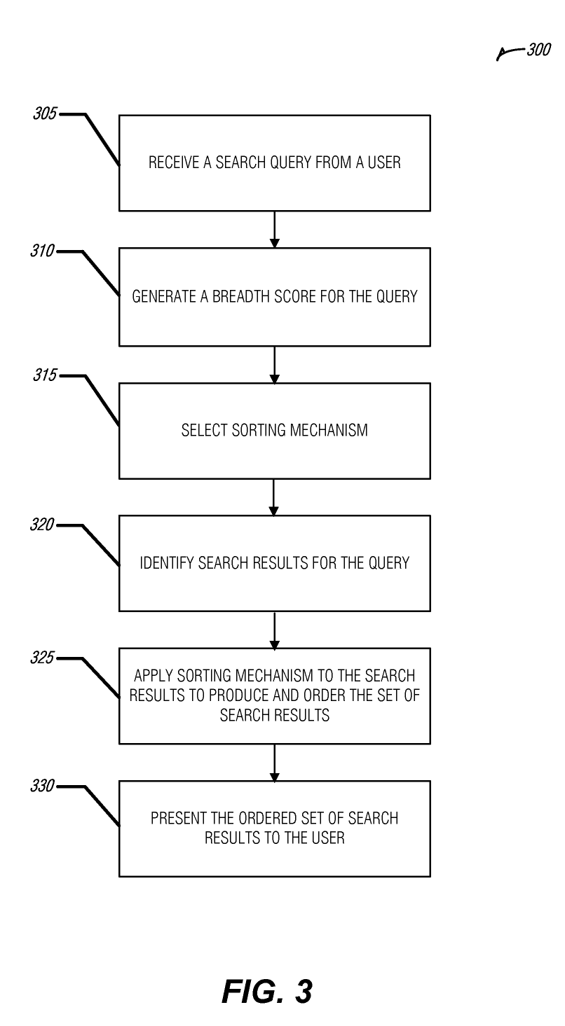

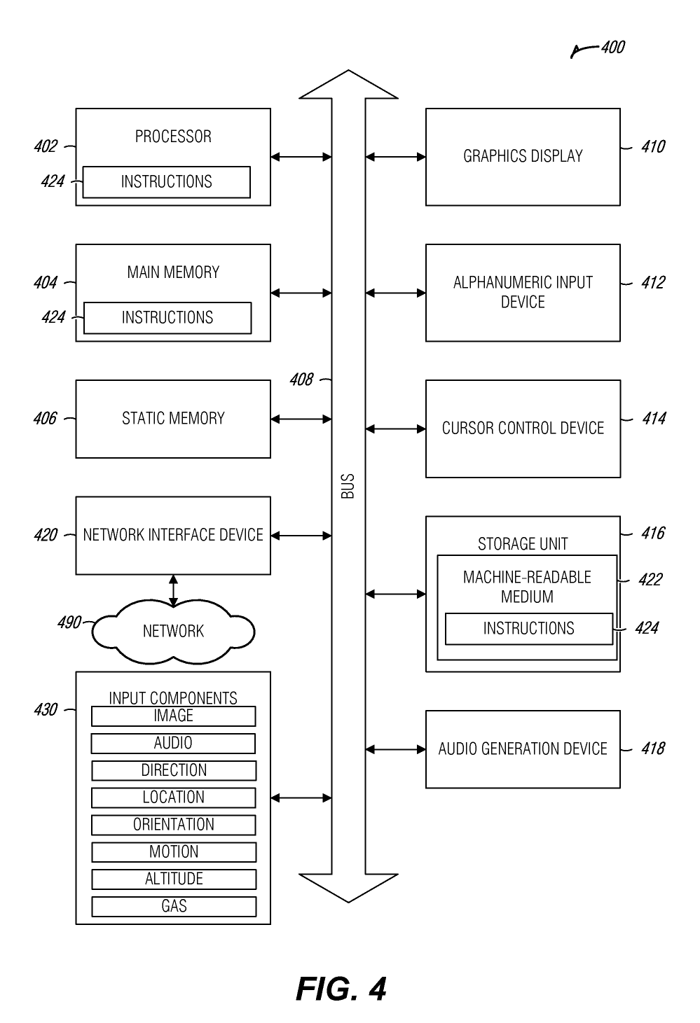

FIG. 3 illustrates a flow diagram of an example of a method 300 for a query-breadth selected search result sort mechanism, according to an embodiment. The operations of the method 300 can be performed by a machine (e.g., such as that described below with regard to FIG. 4) including configured circuits therein.

At operation 305, a search query can be received from a user.

At operation 310, a breadth score can be generated for the search query. In an example, the breadth score can be based on comparing direct and indirect transactions from historical user sessions that included the search query. As noted above, direct transactions are transactions made without an additional related search query following the search query. That is, the user acted on a search result from the search query. Indirect transactions include the additional related search query subsequent to the search query within a given user session from the historical user sessions. That is, the user performed at least a second search query following the search query before acting on a search result. In an example, comparing direct and indirect transactions to calculate the bread score can include dividing the direct transactions by a combination of the direct and indirect transactions. For example, if D represents a count of the direct transactions and I represents a count of the indirect transactions, the comparison can be expressed as

$$\frac{D}{D + I} ;$$

the result is the breadth score. This equation is the same as the ISoTS equation discussed above when the transactions are sales.

At operation 315, a sorting mechanism can be selected from a plurality of sorting mechanisms based on the breadth score. In an example, the plurality of sorting mechanisms can be attribute-models. As discussed above, attribute-models are sorting models that include one or more attributes that are themselves discrete models. In an example, a particular attribute-model can emphasize one attribute over another attribute while a second attribute-model can emphasize the second attribute over the first.

In an example, the attribute-model from the attribute-models selected as the sorting mechanism can be selected based on a relationship between the breadth score and a threshold. For example, if the breadth score exceeds a threshold, an attribute-model corresponding to exceeding that threshold can be selected. In an example, the threshold can divide the range of the breadth score into regions. Accordingly, additional thresholds can be used to divide the breadth score range into many different regions between the various thresholds and the possible upper or lower bound of the breadth score. In an example, each region defined by the threshold (e.g., an upper region, lower region, or region between two thresholds, etc.) can have a corresponding attribute-model assigned to it. Thus, the selected attribute-model can be specific to a first region and a second attribute-model can be specific to a second region.

At operation 320, search results can be identified for the search query.

At operation 325, the sorting mechanism selected at operation 315 can be applied to the search results to produce an ordered set of search results. In an example, the application of the sorting mechanism can also be used as an input into identifying the search results. For example, the sorting mechanism can include an attribute that is stored in the repository from whence the search results come. The attribute can be added to the search query in identifying the search results.

At operation 330, the ordered set of search results can be presented to the user via a search result user interface. As discussed above, the user interface can include any interface to present the search results to the user, including web-based interfaces, mobile device applications, desktop client applications, etc.

### Machine

FIG. 4 is a block diagram illustrating components of a machine 400, according to some example embodiments, able to read instructions 424 from a machine-readable medium 422 (e.g., a non-transitory machine-readable medium, a machine-readable storage medium, a computer-readable storage medium, or any suitable combination thereof) and perform any one or more of the methodologies discussed herein, in whole or in part. Specifically, FIG. 4 shows the machine 400 in the example form of a computer system (e.g., a computer) within which the instructions 424 (e.g., software, a program, an application, an applet, an app, or other executable code) for causing the machine 400 to perform any one or more of the methodologies discussed herein can be executed, in whole or in part.

In alternative embodiments, the machine 400 operates as a standalone device or can be connected (e.g., networked) to other machines. In a networked deployment, the machine 400 can operate in the capacity of a server machine or a client machine in a server-client network environment, or as a peer machine in a distributed (e.g., peer-to-peer) network environment. The machine 400 can be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine 400 capable of executing the instructions 424, sequentially or otherwise, that specify actions to be taken by that machine 400. Further, while only a single machine 400 is illustrated, the term “machine” shall also be taken to include any collection of machines that individually or jointly execute the instructions 424 to perform all or part of any one or more of the methodologies discussed herein.

The machine 400 includes a processor 402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 404, and a static memory 406, which are configured to communicate with each other via a bus 408. The processor 402 can contain microcircuits that are configurable, temporarily or permanently, by some or all of the instructions 424 such that the processor 402 is configurable to perform any one or more of the methodologies described herein, in whole or in part. For example, a set of one or more microcircuits of the processor 402 can be configurable to execute one or more modules (e.g., software modules) described herein.

The machine 400 can further include a graphics display 410 (e.g., a plasma display panel (PDP), a light emitting diode (LED) display, a liquid crystal display (LCD), a projector, a cathode ray tube (CRT), or any other display capable of displaying graphics or video). The machine 400 can also include an alphanumeric input device 412 (e.g., a keyboard or keypad), a cursor control device 414 (e.g., a mouse, a touchpad, a trackball, a joystick, a motion sensor, an eye tracking device, or other pointing instrument), a storage unit 416, an audio generation device 418 (e.g., a sound card, an amplifier, a speaker, a headphone jack, or any suitable combination thereof), and a network interface device 420.

The storage unit 416 includes the machine-readable medium 422 (e.g., a tangible and non-transitory machine-readable storage medium) on which are stored the instructions 424 embodying any one or more of the methodologies or functions described herein. The instructions 424 can also reside, completely or at least partially, within the main memory 404, within the processor 402 (e.g., within the processor's cache memory), or both, before or during execution thereof by the machine 400. Accordingly, the main memory 404 and the processor 402 can be considered machine-readable media 422 (e.g., tangible and non-transitory machine-readable media). The instructions 424 can be transmitted or received over the network 490 via the network interface device 420. For example, the network interface device 420 can communicate the instructions 424 using any one or more transfer protocols (e.g., hypertext transfer protocol (HTTP)).

In some example embodiments, the machine 400 can be a portable computing device, such as a smart phone or tablet computer, and have one or more additional input components 430 (e.g., sensors or gauges). Examples of such input components 430 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 430 can be accessible and available for use by any of the modules described herein.

As used herein, the term “memory” refers to a machine-readable medium 422 able to store data temporarily or permanently and can be taken to include, but not be limited to, random-access memory (RAM), read-only memory (ROM), buffer memory, flash memory, and cache memory. While the machine-readable medium 422 is shown in an example embodiment to be a single medium, the term “machine-readable medium” should be taken to include a single medium or multiple media (e.g., a centralized or distributed database 130, or associated caches and servers) able to store instructions 424. The term “machine-readable medium” shall also be taken to include any medium, or combination of multiple media, that is capable of storing the instructions 424 for execution by the machine 400, such that the instructions 424, when executed by one or more processors of the machine 400 (e.g., processor 402), cause the machine 400 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Certain embodiments are described herein as including logic or a number of components, modules, or mechanisms. Modules can constitute software modules (e.g., code stored or otherwise embodied on a machine-readable medium 422 or in a transmission medium), hardware modules, or any suitable combination thereof. A “hardware module” is a tangible (e.g., non-transitory) unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor 402 or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a field programmable gate array (FPGA) or an ASIC. A hardware module can also include programmable logic or circuitry that is temporarily configured by software to perform certain operations. For example, a hardware module can include software encompassed within a general-purpose processor 402 or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, and such a tangible entity can be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 402 configured by software to become a special-purpose processor, the general-purpose processor 402 can be configured as respectively different special-purpose processors (e.g., comprising different hardware modules) at different times. Software (e.g., a software module) can accordingly configure one or more processors 402, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors 402 that are temporarily configured (e.g., by software) or permanently configured to perform the relevant operations. Whether temporarily or permanently configured, such processors 402 can constitute processor-implemented modules that operate to perform one or more operations or functions described herein. As used herein, “processor-implemented module” refers to a hardware module implemented using one or more processors 402.

Similarly, the methods described herein can be at least partially processor-implemented, a processor 402 being an example of hardware. For example, at least some of the operations of a method can be performed by one or more processors 402 or processor-implemented modules. As used herein, “processor-implemented module” refers to a hardware module in which the hardware includes one or more processors 402. Moreover, the one or more processors 402 can also operate to support performance of the relevant operations in a “cloud computing” environment or as a “software as a service” (SaaS). For example, at least some of the operations can be performed by a group of computers (as examples of machines 400 including processors 402), with these operations being accessible via a network 490 (e.g., the Internet) and via one or more appropriate interfaces (e.g., an application program interface (API)).

The performance of certain operations can be distributed among the one or more processors 402, not only residing within a single machine 400, but deployed across a number of machines 400. In some example embodiments, the one or more processors 402 or processor-implemented modules can be located in a single geographic location (e.g., within a home environment, an office environment, or a server farm). In other example embodiments, the one or more processors 402 or processor-implemented modules can be distributed across a number of geographic locations.

Some portions of the subject matter discussed herein can be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities can take the form of electrical, magnetic, or optical signals capable of being stored, accessed, transferred, combined, compared, or otherwise manipulated by a machine 400. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like can refer to actions or processes of a machine 400 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
a communication module, implemented in a computer system including one or more processors, to receive a search query from a user;
a breadth-score module, implemented in the computer system, to generate a breadth score for the search query;
a selection module, implemented in the computer system, to select a sorting mechanism from a plurality of sorting mechanisms based on the breadth score;
an identification module, implemented in the computer system, to identify search results for the search query;
an application module, implemented in the computer system, to apply the sorting mechanism to the search results to produce an ordered set of search results; and
a presentation module, implemented in the computer system, to present the ordered set of search results to the user via a search result user interface using the communication module.

2. The system of claim 1, wherein the breadth score is based on comparing direct and indirect transactions from historical user sessions including the search query, the direct transactions being transactions made without an additional related search query following the search query, and the indirect transactions include the additional related search query subsequent to the search query within a given user session from the historical user sessions.

3. The system of claim 2, wherein the comparing includes dividing the direct transactions by a combination of the direct and indirect transactions.

4. The system of claim 1, wherein the plurality of sorting mechanisms are attribute-models.

5. The system of claim 4, wherein an attribute-model is selected from the attribute-models based on a relationship between the breadth score and a threshold.

6. The system of claim 5, wherein the threshold divides a range of the breadth score into regions, and wherein the attribute-model is specific to a first region of the regions, and a second attribute-model from the attribute-models is selected for a second region of the regions.

7. The system of claim 4, wherein the sorting mechanism is a combination of a plurality of the attribute-models, the breadth score being a coefficient to each of the attributes in an attribute-model in an additive combination of a plurality of attributes in an attribute-model.

8. A method comprising:
receiving, by a computer system including one or more processors, a search query from a user;
generating, by the computer system, a breadth score for the search query;
selecting, by the computer system, a sorting mechanism from a plurality of sorting mechanisms based on the breadth score;
identifying, by the computer system, search results for the search query;
applying, by the computer system, the sorting mechanism to search results to produce an ordered set of search results; and
presenting the ordered set of search results to the user via a search result user interface.

9. The method of claim 8, wherein the breadth score is based on comparing direct and indirect transactions from historical user sessions including the search query, the direct transactions being transactions made without an additional related search query following the search query, and the indirect transactions include the additional related search query subsequent to the search query within a given user session from the historical user sessions.

10. The method of claim 9, wherein the comparing includes dividing the direct transactions by a combination of the direct and indirect transactions.

11. The method of claim 8, wherein the plurality of sorting mechanisms are attribute-models.

12. The method of claim 11, wherein an attribute-model is selected from the attribute-models based on a relationship between the breadth score and a threshold.

13. The method of claim 12, wherein the threshold divides a range of the breadth score into regions, and wherein the attribute-model is specific to a first region of the regions, and a second attribute-model from the attribute-models is selected for a second region of the regions.

14. The method of claim 11, wherein the sorting mechanism is a combination of a plurality of the attribute-models, the breadth score being a coefficient to each of the attributes in an attribute-model in an additive combination of the attributes in an attribute-model.

15. A non-transitory machine readable medium including instructions that, when executed by a machine, cause the machine to perform operations comprising:
receiving a search query from a user;
generating a breadth score for the search query;
selecting a sorting mechanism from a plurality of sorting mechanisms based on the breadth score;
identifying search results for the search query;
applying the sorting mechanism to the search results to produce an ordered set of search results; and
presenting the ordered set of search results to the user via a search result user interface.

16. The machine readable medium of claim 15, wherein the breadth score is based on comparing direct and indirect transactions from historical user sessions including the search query, the direct transactions being transactions made without an additional related search query following the search query, and the indirect transactions include the additional related search query subsequent to the search query within a given user session from the historical user sessions.

17. The machine readable medium of claim 16, wherein the comparing includes dividing the direct transactions by a combination of the direct and indirect transactions.

18. The machine readable medium of claim 15, wherein the plurality of sorting mechanisms are attribute-models.

19. The machine readable medium of claim 18, wherein an attribute-model is selected from the attribute-models as the sorting mechanism based on a relationship between the breadth score and a threshold.

20. The machine readable medium of claim 19, wherein the threshold divides a range of the breadth score into regions, and wherein the attribute-model is specific to a first region of the regions, and a second attribute-model from the attribute-models is selected for a second region of the regions.

21. The machine readable medium of claim 18, wherein the sorting mechanism is a combination of a plurality of the attribute-models, the breadth score being a coefficient component to each of the attributes in an attribute-model in an additive combination of the attributes in the attribute-model.
